(19) United States
(12) Patent Application Publication
(10) Pub. No.: US 2024/0014375 A1
(43) Pub. Date: Jan. 11, 2024

(54) Lithium Ion Battery

(71) Applicant: JIANGSU ZENIO NEW ENERGY BATTERY TECHNOLOGIES CO., LTD., Jiangsu (CN)

(72) Inventors: Yi YAO, Jiangsu (CN); Shuang LIU, Jiangsu (CN); Haixu HUANG, Jiangsu (CN); Kecheng JIANG, Jiangsu (CN)

(21) Appl. No.: 18/033,308

(22) PCT Filed: Apr. 25, 2021
(86) PCT No.: PCT/CN2021/089564

§ 371 Date: Apr. 21, 2023

(30) Foreign Application Priority Data
Nov. 25, 2020 (CN) 202011336100.3

(51) Int. Cl. H01M 4/131; H01M 4/62; H01M 4/66; H01M 4/38; H01M 4/583; H01M 10/0525

(52) U.S. Cl. CPC H01M 4/131; H01M 4/625; H01M 4/661; H01M 4/386; H01M 4/583; H01M 10/0525; H01M 2004/021

(57) ABSTRACT

Disclosed is a lithium ion battery. The lithium ion battery comprises: a positive electrode piece, comprising a positive electrode coating area and a positive electrode empty foil area, herein the positive electrode coating area has macro-pores and micro-mesopores, the specific surface area of the macro-pores of the positive electrode coating area is 3.0˜7.0 m²/g, and the specific surface area of the micro-mesopores of the positive electrode coating is 2˜5 m²/g; and a negative electrode piece, comprising a negative electrode coating area and a negative electrode empty foil area, herein the negative electrode coating area has macro-pores and micro-mesopores, the specific surface area of the macro-pores of the positive electrode coating area is 0.8˜2.0 m²/g, and the specific surface area of the micro-mesopores of the positive electrode coating is 0.6˜1.7 m²/g. Compared with existing technologies, the lithium ion battery of the present disclosure has excellent rate performance, and may meet the requirements of long service life and high power of hybrid electric vehicles (HEV).

### CROSS-REFERENCE TO RELATED APPLICATION

The present application claims priority to Chinese patent application 202011336100.3 filed to the China National Intellectual Property Administration on Nov. 25, 2020 and entitled “Lithium Ion Battery”, the disclosure of which is hereby incorporated by reference in its entirety.

### TECHNICAL FIELD

The present disclosure belongs to the technical field of batteries, in particular to a lithium ion battery.

### BACKGROUND

Hybrid electric vehicles (HEV) are a new energy vehicle with the advantages of low fuel consumption, low emission pollution, no mileage anxiety and the like. It adds a set of electric drive devices on the basis of original gasoline vehicles, and may make use of the advantages of two working modes. Since a motor has the advantage of maximum torque by nature, the motor may assist an engine to work while the HEV-model vehicle needs large torque output such as vehicle starting, climbing and rapid acceleration, thus the vehicle is helped to reduce energy consumption, and the purpose of energy conservation is achieved.

Lithium ion batteries have outstanding advantages such as high energy density, long cycle life, high working voltage, lower self-discharge rate and environmental friendliness, and may be used as an ideal power supply for HEV motors. However, compared with ordinary lithium ion batteries for electric vehicles, HEV batteries need excellent high-rate charging-discharging capacity, and existing lithium ion batteries may not meet this demand.

In view of this, it is necessary to provide a lithium ion battery to solve the above technical problems.

### SUMMARY

A purpose of the present disclosure is to provide a lithium ion battery, which has an excellent rate performance, and may meet the requirements of long service life and high power of HEV in view of the shortcomings of existing technologies.

In order to achieve the above purpose, the present disclosure adopts the following technical schemes.

A lithium ion battery, comprising:
a positive electrode piece, comprising a positive electrode coating area and a positive electrode empty foil area, wherein the positive electrode coating area has macro-pores and micro-mesopores, the specific surface area of the macro-pores of the positive electrode coating area is 3.0˜7.0 m²/g, and the specific surface area of the micro-mesopores of the positive electrode coating is 2˜5m²/g; and
a negative electrode piece, comprising a negative electrode coating area and a negative electrode empty foil area, wherein the negative electrode coating area has macro-pores and micro-mesopores, the specific surface area of the macro-pores of the positive electrode coating area of the negative electrode coating area is 0.8˜2.0 m²/g, and the specific surface area of the micro-mesopores of the positive electrode coating of the negative electrode coating area is 0.6˜1.7 m²/g.

As an improvement of the lithium ion battery described in the present disclosure, the positive electrode coating area comprises a positive electrode current collector and a positive electrode material layer coated on the surface of the positive electrode current collector, and the compacted density of the positive electrode material layer is 2.6 g/cm³˜3.3 g/cm³.

As an improvement of the lithium ion battery described in the present disclosure, the negative electrode coating area comprises a negative electrode current collector and a negative electrode material layer coated on the surface of the negative electrode current collector, and the compacted density of the negative electrode material layer is 1.0 g/cm³˜1.6 g/cm³.

As an improvement of the lithium ion battery described in the present disclosure, the positive electrode material layer comprises a positive electrode active material, a positive electrode conductive agent and a positive electrode adhesive, and the positive electrode conductive agent accounts for 3.0˜8.0% of the total mass of the positive electrode material layer.

As an improvement of the lithium ion battery described in the present disclosure, the positive electrode active material comprises at least one of a lithium nickel cobalt manganate oxide ternary material, a lithium iron phosphate material, a lithium manganate material, a lithium cobalt oxide material, a lithium nickel cobalt manganate oxide ternary material modified by doping and coating, and a carbon-coated lithium iron phosphate material.

As an improvement of the lithium ion battery described in the present disclosure, the positive electrode conductive agent comprises at least one of activated carbon, carbon black, carbon nanotube, graphite, soft carbon, hard carbon and amorphous carbon; and the positive electrode adhesive comprises at least one of styrene-butadiene rubber, polyacrylamide, polyvinylidene fluoride, polytetrafluoroethylene, polyacrylonitrile and polyimide.

As an improvement of the lithium ion battery described in the present disclosure, the negative electrode material layer comprises a negative electrode active material, a negative electrode conductive agent and a negative electrode adhesive, and the negative electrode conductive agent accounts for 0.5˜3.0% of the total mass of the negative electrode material layer.

As an improvement of the lithium ion battery described in the present disclosure, the negative electrode active material comprises at least one of artificial graphite, natural graphite, silicon, silicon oxide, tin element and lithium titanate.

As an improvement of the lithium ion battery described in the present disclosure, the negative electrode conductive agent comprises at least one of activated carbon, carbon black, carbon nanotube, graphite, soft carbon, hard carbon and amorphous carbon; and the negative electrode adhesive comprises at least one of styrene-butadiene rubber, polyacrylamide, polyvinylidene fluoride, polytetrafluoroethylene, polyacrylonitrile and polyimide.

As an improvement of the lithium ion battery described in the present disclosure, the positive electrode current collector is an aluminum foil, and the negative electrode current collector is a copper foil.

Compared with the existing technologies, the beneficial effects of the present disclosure include but are not limited to: the present disclosure adjusts the specific surface areas of the micro-mesopores and the macro-pores in the coating area of the electrode piece to a suitable range respectively. Herein, because the micro-mesopore diameter is often lower than the critical radius of an electrolyte, the electrolyte has a better liquid retention effect in it, thus the battery has a longer service life in the long-term operation process; and the macro-pores provide a main path for lithium ion transmission in the coating layer, so that the battery performs better under a high rate charging-discharging working conditions. Therefore, the lithium ion battery of the present disclosure has an excellent charging-discharging performance, and has a better service life under the high rate charging-discharging cycle working conditions.

### DETAILED DESCRIPTION OF THE EMBODIMENTS

Implementation modes of the present disclosure may be described in detail below. The implementation modes of the present disclosure should not be construed as limiting the present disclosure.

The present disclosure provides a lithium ion battery, comprising:
a positive electrode piece, comprising a positive electrode coating area and a positive electrode empty foil area, wherein the positive electrode coating area has macro-pores and micro-mesopores, the specific surface area of the macro-pores of the positive electrode coating area is 3.0˜7.0 m²/g, and the specific surface area of the micro-mesopores of the positive electrode coating is 2˜5 m²/g; and
a negative electrode piece, comprising a negative electrode coating area and a negative electrode empty foil area, wherein the negative electrode coating area has macro-pores and micro-mesopores, the specific surface area of the macro-pores of the positive electrode coating area of the negative electrode coating area is 0.8˜2.0 m²/g, and the specific surface area of the micro-mesopores of the positive electrode coating of the negative electrode coating area is 0.6˜1.7 m²/g.

The lithium ion battery involves a series of mass transfer processes and reaction processes such as electron conduction, ion conduction, electrochemical reaction, chemical reaction and phase change, and the structure of its electrode piece is closely related to the electrical performance. The structure of a pore channel determines a moving path of lithium ions, and has a significant impact on the rate performance of the battery. Therefore, the optimization of the pore channel structure of the electrode piece becomes an important means to improve the performance of the battery. Herein, the micro-mesopores come from the microstructures of the positive and negative electrode active materials, the conductive agent, the adhesive agent and other materials, and it is related to the selection of its types and the proportion of use; however, the macro-pores often come from gaps caused by accumulation of the active materials. The two may play different roles in the battery operation process. The pore diameter of the micro-mesopores is often lower than the critical radius of an electrolyte, so that the electrolyte has a better liquid retention effect in it, thereby the battery has a longer service life in the long-term operation process. The macro-pores provide a main path for lithium ion transmission in the coating layer, so that the battery performs better under a high rate charging-discharging working conditions. However, the pore channel structure is more developed, it is not the better. Because too many micro-mesopore structures may become the center of side reactions of the battery, it worsens the performance of the battery at a high temperature; and the over-developed macro-pores often mean low compaction and low energy density. Therefore, the present disclosure adjusts the specific surface areas of the micro-mesopores and the macro-pores of the electrode piece to a suitable range, so that the battery has an excellent charging-discharging performance and a better service life under the high-rate charging-discharging cycle working conditions.

In some implementation modes of the lithium ion battery described in the present disclosure, the positive electrode coating area comprises a positive electrode current collector and a positive electrode material layer coated on the surface of the positive electrode current collector, and the compacted density of the positive electrode material layer is 2.6 g/cm³˜3.3 g/cm³. Specifically, the compacted density of the positive electrode material layer may be 2.6 cm³, 2.65 cm³, 2.7 cm³, 2.75 cm³, 2.8 cm³, 2.85 cm³, 2.9 cm³, 2.95 cm³, 3.0 cm³, 3.05 cm³, 3.1 cm³, 3.15 cm³, 3.2 cm³, 3.25 cm³ and 3.3 cm³. If the compacted density is too small, it may reduce the energy density of the battery. If the compacted density is too large, and the specific surface area of the macro-pores of the positive electrode coating area is too small, it may affect the transmission of lithium ions, and affect the high-rate charging-discharging performance of the battery.

In some implementation modes of the lithium ion battery described in the present disclosure, the negative electrode coating area comprises a negative electrode current collector and a negative electrode material layer coated on the surface of the negative electrode current collector, and the compacted density of the negative electrode material layer is 1.0 g/cm³˜1.6 g/cm³. Specifically, the compacted density of the negative electrode material layer may be 1.0 cm³, 1.05 cm³, 1.1 cm³, 1.15 cm³, 1.2 cm³, 1.25 cm³, 1.3 cm³, 1.35 cm³, 1.4 cm³, 1.45 cm³, 1.5 cm³, 1.55 cm³ and 1.6 cm³. If the compacted density is too small, it may reduce the energy density of the battery. If the compacted density is too large, and the specific surface area of the macro-pores of the positive electrode coating area is too small, it may affect the transmission of the lithium ions, and affect the high-rate charging-discharging performance of the battery.

In some implementation modes of the lithium ion battery described in the present disclosure, the positive electrode material layer comprises a positive electrode active material, a positive electrode conductive agent and a positive electrode adhesive, and the positive electrode conductive agent accounts for 3.0˜8.0% of the total mass of the positive electrode material layer. The content of the conductive agent affects the specific surface area of the micro-mesopores of the positive electrode coating. While the content of the conductive agent is low, the specific surface area of the micro-mesopores of the positive electrode coating is also correspondingly low, and the pore diameter of the micro-mesopores is often lower than the critical radius of the electrolyte, so that the electrolyte has a better liquid retention effect in it. While the specific surface area of the micro-mesopores of the positive electrode coating is too low, it may reduce the liquid retention capacity, thus the service life of the battery is reduced.

In some implementation modes of the lithium ion battery described in the present disclosure, the positive electrode active material comprises at least one of a lithium nickel cobalt manganate oxide ternary material, a lithium iron phosphate material, a lithium manganate material, a lithium cobalt oxide material, a lithium nickel cobalt manganate oxide ternary material modified by doping and coating, and a carbon-coated lithium iron phosphate material. Preferably, the lithium nickel cobalt manganate oxide ternary material is selected as the positive electrode active material, the particle size distribution of the material satisfies 2 μm<D50<6 μm, and the primary particle size d of the material satisfies 500 nm<d<3 ∥m. The particle size distribution and primary particle size of the material may affect the specific surface areas of the macro-pores and micro-mesopores. Generally, in terms of performance, it is difficult to control the process and compact the material with too small particle size during use; if the particle size is too large, the material is easy to crack in the rolling process, which affects the stability of the material; the stability of the material with too small primary particle size (especially high-temperature stability) may become worse, while the dynamic performance of the material with too large primary particle size may become worse; and in terms of specific surface area, under the same compacted density, the particle size is smaller, the specific surface area of the macro-pores of the positive electrode coating area is larger, and the particle size is larger, the specific surface area of the macro-pores of the positive electrode coating area is smaller.

In some implementation modes of the lithium ion battery described in the present disclosure, the positive electrode conductive agent comprises at least one of activated carbon, carbon black, carbon nanotube, graphite, soft carbon, hard carbon and amorphous carbon; and the positive electrode adhesive comprises at least one of styrene-butadiene rubber, polyacrylamide, polyvinylidene fluoride, polytetrafluoroethylene, polyacrylonitrile and polyimide.

In some implementation modes of the lithium ion battery described in the present disclosure, the negative electrode material layer comprises a negative electrode active material, a negative electrode conductive agent and a negative electrode adhesive, and the negative electrode conductive agent accounts for 0.5˜3.0% of the total mass of the negative electrode material layer. The content of the conductive agent affects the specific surface area of the micro-mesopores of the positive electrode coating. While the content of the conductive agent is low, the specific surface area of the micro-mesopores of the positive electrode coating is also correspondingly low, and the pore diameter of the micro-mesopores is often lower than the critical radius of the electrolyte, so that the electrolyte has the better liquid retention effect in it. While the specific surface area of the micro-mesopores of the positive electrode coating is too low, it may reduce the liquid retention capacity, thus the service life of the battery is reduced.

In some implementation modes of the lithium ion battery described in the present disclosure, the negative electrode active material comprises at least one of artificial graphite, natural graphite, silicon, silicon oxide, tin element and lithium titanate. Preferably, the artificial graphite material is selected as the negative electrode active material, the particle size distribution of the material satisfies 3 ∥m<D50<10 ∥m, and the primary particle sized of the material satisfies 2 μm<d<8 μm. The particle size distribution and primary particle size of the material may affect the specific surface areas of the macro-pores and micro-mesopores. Generally, in terms of performance, it is difficult to control the process and compact the material with too small particle size in the process of use; if the particle size is too large, the material is easy to crack in the rolling process, which affects the stability of the material; the stability of the material with too small primary particle size (especially high-temperature stability) may become worse, while the dynamic performance of the material with too large primary particle size may become worse; and in terms of specific surface area, under the same compacted density, the particle size is smaller, the specific surface area of the macro-pores of the positive electrode coating area is larger, and the particle size is larger, the specific surface area of the macro-pores of the positive electrode coating area is smaller.

In some implementation modes of the lithium ion battery described in the present disclosure, the negative electrode conductive agent comprises at least one of activated carbon, carbon black, carbon nanotube, graphite, soft carbon, hard carbon and amorphous carbon; and the negative electrode adhesive comprises at least one of styrene-butadiene rubber, polyacrylamide, polyvinylidene fluoride, polytetrafluoroethylene, polyacrylonitrile and polyimide.

In some implementation modes of the lithium ion battery described in the present disclosure, the positive electrode current collector is an aluminum foil, and the negative electrode current collector is a copper foil.

The implementation schemes of the present disclosure are illustrated with examples below in combination with embodiments. It should be understood that these embodiments are only used to illustrate the present disclosure and are not intended to limit a scope of protection claimed by the present disclosure.

### EMBODIMENTS 1˜5 AND CONTRAST EXAMPLES 1˜8

A lithium ion battery, its preparation method comprises the following steps:
1) positive electrode active material powder, conductive carbon, carbon nanotubes and polyvinylidene fluoride (PVDF) are mixed in a specified proportion, then N-methylpyrrolidone (NMP) is added in a high-speed mixer and evenly mixed into a slurry material with a solid content of 74%; the slurry material is coated on the single side of the aluminum foil with a thickness of 12 microns by a transfer coater, and dried, and the weight of the dried coating layer per unit area is 17.8 mg/cm²; then the other side of the aluminum foil is coated and dried by the same working procedure to obtain a semi-finished product of the positive electrode piece;
2) negative electrode active material powder, conductive carbon, carbon nanotubes, carboxymethyl cellulose (CMC) and polymerized styrene butadiene rubber (SBR) are mixed in a specified proportion, and then deionized water is added in the high-speed mixer and evenly mixed into a slurry material with a solid content of 48%; the slurry material is coated on the single side of the copper foil with a thickness of 8 microns by the transfer coater, and dried, and the weight of the dried coating layer per unit area is 10.4 mg/cm²; then the other side of the copper foil is coated and dried by the same working procedure to obtain a semi-finished product of the negative electrode piece; and
3) an exposed metal foil part of the above electrode piece is processed and welded into an electrode lug, and then wound with an isolating film to form a coil core; the aluminum plastic film is used to wrap the coil core to prepare a semi-finished battery core, and then the electrolyte is injected into it, and the finished lithium ion battery is obtained by steps of formation and volume separation.

### Performance Test

1) Discharge rate test: the above preparation method is used and a soft-packing lithium ion battery with a capacity of 2 Ah is prepared according to the requirements of various parameters in Tables 1˜2, its state of charge (SOC) is adjusted to 50%, and then it is discharged at 80 A current, and the elapsed time is counted while the voltage drops to 2.5 V.
2) High-rate cycle test: the above preparation method is used and a soft-packing lithium ion battery with a capacity of 2 Ah is prepared according to the requirements of various parameters in Tables 1˜2, charging-discharging cycle is performed at 6 A current within the voltage range of 2.8˜4.2 V, and the number of cycles elapsed while the battery capacity retention rate is decreased to 80% is counted.

The above test results are shown in Table 3.

TABLE 1
Details of electrode materials

| | | | Particle size | Average primary |
|---|---|---|---|---|
| Number | Electrode | Active substance | D50/μm | particle size/μm |
| Embodiments 1~5 and | Positive | Lithium nickel | 2.8 | 1.12 |
| Contrast examples 1~3 | electrode | cobalt manganate 1 | | |
| | Negative | Artificial graphite 1 | 5.4 | 4.8 |
| | electrode | | | |
| Contrast example 4 | Positive | Lithium nickel | 2.8 | 1.12 |
| | electrode | cobalt manganate 1 | | |
| | Negative | Artificial graphite 2 | 15.6 | 10.3 |
| | electrode | | | |
| Contrast example 5 | Positive | Lithium nickel | 2.8 | 1.12 |
| | electrode | cobalt manganate 1 | | |
| | Negative | Artificial graphite 3 | 20.7 | 12.7 |
| | electrode | | | |
| Contrast example 6 | Positive | Lithium nickel | 9.4 | 0.37 |
| | electrode | cobalt manganate 2 | | |
| | Negative | Artificial graphite 1 | 5.4 | 4.8 |
| | electrode | | | |
| Contrast example 7 | Positive | Lithium nickel | 4.2 | 3.54 |
| | electrode | cobalt manganate 3 | | |
| | Negative | Artificial graphite 1 | 5.4 | 4.8 |
| | electrode | | | |
| Contrast example 8 | Positive | Lithium nickel | 9.4 | 0.37 |
| | electrode | cobalt manganate 2 | | |
| | Negative | Artificial graphite 2 | 15.6 | 10.3 |
| | electrode | | | |

TABLE 2
Details of process parameters

| | | | | Macro-pore | |
|---|---|---|---|---|---|
| | | Compacted | Conductive | specific | Micro-mesopore |
| | | density | carbon | surface | specific surface |
| Number | Electrode | (g/cm³) | content (%) | area(m²/g) | area (m²/g) |
| Embodiment | Positive | 3.00 | 5.0 | 5.90 | 4.20 |
| 1 | electrode | | | | |
| | Negative | 1.45 | 2.0 | 1.30 | 1.20 |
| | electrode | | | | |
| Embodiment | Positive | 2.60 | 5.0 | 6.10 | 4.20 |
| 2 | electrode | | | | |
| | Negative | 0.80 | 2.0 | 1.50 | 1.20 |
| | electrode | | | | |
| Embodiment | Positive | 3.30 | 5.0 | 5.60 | 4.20 |
| 3 | electrode | | | | |
| | Negative | 2.00 | 2.0 | 1.10 | 1.20 |
| | electrode | | | | |
| Embodiment | Positive | 3.00 | 3.0 | 5.90 | 3.20 |
| 4 | electrode | | | | |
| | Negative | 1.45 | 0.5 | 1.30 | 0.30 |
| | electrode | | | | |
| Embodiment | Positive | 3.00 | 8.0 | 5.90 | 5.20 |
| 5 | electrode | | | | |
| | Negative | 1.45 | 3.0 | 1.30 | 2.20 |
| | electrode | | | | |
| Contrast | Positive | 3.45 | 5.0 | 1.70 | 4.20 |
| example 1 | electrode | | | | |
| | Negative | 1.65 | 2.0 | 1.00 | 1.20 |
| | electrode | | | | |
| Contrast | Positive | 3.00 | 5.0 | 5.90 | 4.20 |
| example 2 | electrode | | | | |
| | Negative | 1.45 | 1.0 | 1.30 | 0.55 |
| | electrode | | | | |
| Contrast | Positive | 3.45 | 2.0 | 1.70 | 1.70 |
| example 3 | electrode | | | | |
| | Negative | 1.20 | 3.5 | 2.15 | 1.90 |
| | electrode | | | | |
| Contrast | Positive | 3.00 | 5.0 | 5.90 | 4.20 |
| example 4 | electrode | | | | |
| | Negative | 1.45 | 2.0 | 1.25 | 1.20 |
| | electrode | | | | |
| Contrast | Positive | 2.5 | 5.0 | 5.90 | 4.20 |
| example 5 | electrode | | | | |
| | Negative | 1.65 | 2.0 | 1.30 | 1.20 |
| | electrode | | | | |
| Contrast | Positive | 3.00 | 5.0 | 5.90 | 4.20 |
| example 6 | electrode | | | | |
| | Negative | 1.45 | 2.0 | 1.30 | 1.20 |
| | electrode | | | | |
| Contrast | Positive | 2.50 | 5.0 | 8.20 | 4.20 |
| example 7 | electrode | | | | |
| | Negative | 1.20 | 2.0 | 2.30 | 1.10 |
| | electrode | | | | |
| Contrast | Positive | 3.45 | 2.0 | 1.50 | 1.55 |
| example 8 | electrode | | | | |
| | Negative | 1.65 | 1.0 | 0.90 | 0.70 |
| | electrode | | | | |

TABLE 3
Test results

| | 50% SOC 40 C | 3 C number of charging- |
|---|---|---|
| Number | Discharge duration time/s | discharging cycles |
| Embodiment 1 | 35.00 | 5000 |
| Embodiment 2 | 36.00 | 5100 |
| Embodiment 3 | 33.00 | 4700 |
| Embodiment 4 | 34.00 | 4500 |
| Embodiment 5 | 33.00 | 4800 |
| Contrast example 1 | 27.00 | 3700 |
| Contrast example 2 | 33.00 | 4200 |
| Contrast example 3 | 25.00 | 2000 |
| Contrast example 4 | 32.00 | 3500 |
| Contrast example 5 | 24.00 | 1700 |
| Contrast example 6 | 33.00 | 4000 |
| Contrast example 7 | 20.00 | 3000 |
| Contrast example 8 | 23.00 | 1200 |

It may be seen from the various parameters of the embodiments and contrast examples in Table 1˜2 and the test results in Table 3.

It may be seen from the comparison between Embodiments 1˜5 and Contrast example 1 that while the compacted density of the electrode material layer is increased, the specific surface area of the macro-pores of the positive electrode coating area may be decreased, thus the charging-discharging performance and service life of the battery are affected; it may be seen from the comparison between Embodiments 1˜5 and Contrast example 2 that while the content of the conductive agent in the electrode material layer is decreased, the specific surface area of the micro-mesopores of the positive electrode coating may be decreased, thus the charging-discharging performance and service life of the battery are affected; it may be seen from the comparison between Embodiments 1˜5 and Contrast examples 1˜3 that while the compacted density, the content of the conductive agent, the specific surface area of macro-pores and the specific surface area of micro-mesopores are all not within the limited range, the battery thereof has the worst charging-discharging performance and the lowest service life. In addition, it may be seen from the comparison between Embodiment 1 and Contrast examples 4˜7 that while the particle size and primary particle size of the active substance in the electrode material layer are too large or too small, it may also affect the charging-discharging performance and service life of the battery. It may be seen from the comparison between Embodiments 1˜5 and Contrast examples 1˜8 that while all parameters do not fall within the limited range of the present disclosure (Contrast example 8), the effect thereof is the worst.

In conclusion, if and only if the average particle size and primary particle size of the electrode active material are within the limited range of the present disclosure, and the compacted density, the content of the conductive agent, the macro-pore specific surface area and the micro-mesopore specific surface area are also within the limited range of the present disclosure, the battery has a long discharge duration time and good cycle performance, namely the battery of the present disclosure has an excellent charging-discharging performance, and has a better service life under high-rate charging-discharging cycle working conditions.

According to the disclosure and instruction of the above description, those skilled in the art of the present disclosure may also make changes and modifications to the above implementation modes. Therefore, the present disclosure is not limited to the above specific implementation modes. Any apparent improvements, replacements or modifications made by those skilled in the art on the basis of the present disclosure belong to a scope of protection of the present disclosure. In addition, although some specific terms are used in this description, these terms are only for convenient description, and do not constitute any limitation to the present disclosure.

What is claimed is:

1. A lithium ion battery, comprising:
a positive electrode piece, comprising a positive electrode coating area and a positive electrode empty foil area, wherein the positive electrode coating area has macro-pores and micro-mesopores, the specific surface area of the macro-pores of the positive electrode coating area is 3.0˜7.0 m²/g, and the specific surface area of the micro-mesopores of the positive electrode coating is 2˜5 m²/g; and
a negative electrode piece, comprising a negative electrode coating area and a negative electrode empty foil area, wherein the negative electrode coating area has macro-pores and micro-mesopores, the specific surface area of the macro-pores of the positive electrode coating area is 0.8˜2.0 m²/g, and the specific surface area of the micro-mesopores of the positive electrode coating is 0.6˜1.7 m²/g.

2. The lithium ion battery according to claim 1, wherein the positive electrode coating area comprises a positive electrode current collector and a positive electrode material layer coated on the surface of the positive electrode current collector, and the compacted density of the positive electrode material layer is 2.6 g/cm³˜3.3 g/cm³.

3. The lithium ion battery according to claim 1, wherein the negative electrode coating area comprises a negative electrode current collector and a negative electrode material layer coated on the surface of the negative electrode current collector, and the compacted density of the negative electrode material layer is 1.0 g/cm³˜1.6 g/cm³.

4. The lithium ion battery according to claim 2, wherein the positive electrode material layer comprises a positive electrode active material, a positive electrode conductive agent and a positive electrode adhesive, and the positive electrode conductive agent accounts for 3.0˜8.0% of the total mass of the positive electrode material layer.

5. The lithium ion battery according to claim 4, wherein the positive electrode active material comprises at least one of a lithium nickel cobalt manganate oxide ternary material, a lithium iron phosphate material, a lithium manganate material, a lithium cobalt oxide material, a lithium nickel cobalt manganate oxide ternary material modified by doping and coating, and a carbon-coated lithium iron phosphate material.

6. The lithium ion battery according to claim 4, wherein the positive electrode conductive agent comprises at least one of activated carbon, carbon black, carbon nanotube, graphite, soft carbon, hard carbon and amorphous carbon; and the positive electrode adhesive comprises at least one of styrene-butadiene rubber, polyacrylamide, polyvinylidene fluoride, polytetrafluoroethylene, polyacrylonitrile and polyimide.

7. The lithium ion battery according to claim 3, wherein the negative electrode material layer comprises a negative electrode active material, a negative electrode conductive agent and a negative electrode adhesive, and the negative electrode conductive agent accounts for 0.5˜3.0% of the total mass of the negative electrode material layer.

8. The lithium ion battery according to claim 7, wherein the negative electrode active material comprises at least one of artificial graphite, natural graphite, silicon, silicon oxide, tin and lithium titanate.

9. The lithium ion battery according to claim 7, wherein the negative electrode conductive agent comprises at least one of activated carbon, carbon black, carbon nanotube, graphite, soft carbon, hard carbon and amorphous carbon; and the negative electrode adhesive comprises at least one of styrene-butadiene rubber, polyacrylamide, polyvinylidene fluoride, polytetrafluoroethylene, polyacrylonitrile and polyimide.

10. The lithium ion battery according to claim 1, wherein the positive electrode current collector is an aluminum foil, and the negative electrode current collector is a copper foil.
